(19) United States
(12) Patent Application Publication
(10) Pub. No.: US 2014/0106932 A1
(43) Pub. Date: Apr. 17, 2014

(54) ENGINE AUTOMATIC CONTROL SYSTEM AND ENGINE AUTOMATIC CONTROL METHOD

(71) Applicant: Chiyoko Kato, Toyota-shi (JP)

(72) Inventors: Minoru Kato, Toyota-shi (JP); Tetsuya Okuda, Toyota-shi (JP)

(73) Assignee: TOYOTA JIDOSHA KABUSHIKI KAISHA, Toyota-shi, Aichi-ken (JP)

(21) Appl. No.: 13/993,447

(22) PCT Filed: Nov. 29, 2011
(86) PCT No.: PCT/IB2011/002857

§ 371 Date: Dec. 24, 2013

(30) Foreign Application Priority Data
Dec. 14, 2010 (JP) 2010-278387

(51) Int. Cl. B60W 10/02; B60W 10/10; B60W 10/06

(52) U.S. Cl. CPC B60W 10/02; B60W 10/06; B60W 10/10
USPC 477/83

(57) ABSTRACT

An engine automatic control system includes: a clutch that changes between transmission of power, generated by an engine, to a drive wheel and interruption of the power to the drive wheel; a clutch pedal that engages or disengages the clutch to operate an engagement state of the clutch; and an ECU that stops or starts the engine on the basis of an operation of the clutch pedal. The ECU starts the engine on the basis of an operation mode in which the clutch pedal is operated to engage the clutch during a stop of the engine.

### BACKGROUND OF THE INVENTION

1. Field of the Invention

The invention relates to an engine automatic control system and an engine automatic control method.

2. Description of Related Art

In a recent vehicle, for the purpose of improving fuel economy, reducing emissions of exhaust gas, and the like, there has been developed a control technique for stopping an engine to coast the vehicle when driving force is not required by a driver during vehicle running or stopping an engine when the vehicle is temporarily stopped. For example, Japanese Patent Application Publication No. 9-42004 (JP-A-9-42004) describes an engine automatic stop-start system. The engine automatic stop-start system automatically stops an engine when a predetermined stop condition, including a state where the vehicle speed is zero and the transmission is neutral, is satisfied, and automatically starts the engine when the clutch pedal is depressed beyond a predetermined amount in a state where the engine is automatically stopped. Furthermore, the engine automatic stop-start system prohibits an automatic start of the engine when there is a history that the transmission has been placed at a position other than a neutral position before the clutch pedal is depressed beyond the predetermined amount in a state where the engine is automatically stopped. This prevents an unnecessary start of the engine when the driver has no intention of driving the vehicle.

In this way, in the vehicle that automatically starts and automatically stops the engine, further improvement in fuel economy may be expected by extending an engine stop time as much as possible. When automatic control is executed on a vehicle having a clutch pedal, the engine is automatically started when the clutch is engaged to thereby make it possible to extend the engine stop time. That is, the engine is automatically started after an automatic stop of the engine at the timing at which the clutch pedal is returned in a state where the clutch pedal is depressed and the low gear or back gear of the transmission is selected. By so doing, the engine start timing delays, so the engine stop time may be extended.

Here, when the engine is stopped and the vehicle is brought to a stop, the vehicle may stop in a state where a low-speed gear, such as a low gear and a back gear, of the transmission is selected in order to further reliably keep the vehicle stopped. However, in the case of the vehicle that automatically starts the engine at the timing at which the clutch pedal is returned, when the driver depresses the clutch pedal in a state where the engine is stopped, the low-speed gear of the transmission is selected and then the clutch pedal is returned in order to bring the vehicle to a stop, the engine may be started. In this way, when control for delaying the timing at which the engine is automatically started is executed, it is difficult to appropriately interpret a driver's intention and then appropriately execute control along the driver's intention.

### SUMMARY OF THE INVENTION

The invention provides an engine automatic control system and engine automatic control method that are able to achieve both improvement in fuel economy during vehicle driving and appropriate running control along a driver's intention. Particularly, the invention provides an engine automatic control system and engine automatic control method that are able to achieve both improvement in fuel economy by stopping an engine during vehicle driving and appropriate start control along a driver's intention.

A first aspect of the invention provides an engine automatic control system. The engine automatic control system includes: a clutch that changes between transmission of power, generated by a power source, to a drive wheel or interruption of the power to the drive wheel; a clutch operator that engages or disengages the clutch to operate an engagement state of the clutch; and a control unit that reduces the power generated by the power source when the clutch is disengaged by the clutch operator, and that increases the power generated by the power source when the clutch is engaged by the clutch operator.

A second aspect of the invention provides an engine automatic control system. The engine automatic control system includes: a clutch that changes between transmission of power, generated by a power source, to a drive wheel or interruption of the power to the drive wheel; a clutch operator that engages or disengages the clutch to operate an engagement state of the clutch; and a control unit that increases the power generated by the power source when the clutch is engaged by the clutch operator, wherein the control unit changes a way of increasing the power on the basis of an operation mode of the clutch operator.

A third aspect of the invention relates to an engine automatic control system. The engine automatic control system includes: a clutch that changes between transmission of power, generated by a power source, to a drive wheel or interruption of the power to the drive wheel; a clutch operator that engages or disengages the clutch to operate an engagement state of the clutch; and a control unit that stops or starts the power source on the basis of an operation of the clutch operator, wherein the control unit starts the power source on the basis of an operation mode in which the clutch operator is operated to engage the clutch during a stop of the power source.

In the engine automatic control system, the control unit may select starting the power source or keeping the power source stopped on the basis of an operating speed at which the clutch operator is operated to engage the clutch during a stop of the power source.

The engine automatic control system may further include an operation range end detector that detects that the clutch operator is placed at any one of a depressing-side end and return-side end of an operation range within which the clutch operator is operated, wherein, in a case where the clutch operator is operated to engage the clutch during a stop of the power source, when a period of time from when the operation range end detector detects that the clutch operator has left from the depressing-side end to when the operation range end detector detects that the clutch operator has reached the return-side end is shorter than a reference time, the control unit may keep the power source stopped.

In the engine automatic control system, when the power source is started by operating the clutch operator to engage the clutch during a stop of the power source, the control unit may interpret whether a driver of a vehicle has an intention of starting the vehicle on the basis of a return speed at which the clutch operator is returned in an intermediate range within an operation range within which the clutch operator is operated.

A fourth aspect of the invention provides an engine automatic control system that stops or starts a power source during running of a vehicle on the basis of driving force required by a driver of the vehicle. The engine automatic control system includes: a clutch that changes between transmission of power, generated by the power source, to a drive wheel or interruption of the power to the drive wheel; a clutch operator that operates an engagement state of the clutch; an accelerator operator that adjusts the power generated by the power source; and a control unit that selects starting the power source or keeping the power source stopped on the basis of an operation state of the accelerator operator after the clutch operator has begun to be returned during a stop of the power source.

A fifth aspect of the invention provides an engine automatic control method using a clutch operator that engages or disengages a clutch, which changes between transmission of power, generated by a power source, to a drive wheel and interruption of the power to the drive wheel, to operate an engagement state of the clutch. The engine automatic control method includes: reducing the power generated by the power source when the clutch is disengaged by the clutch operator; and increasing the power generated by the power source when the clutch is engaged by the clutch operator.

A sixth aspect of the invention provides an engine automatic control method using a clutch operator that engages or disengages a clutch, which changes between transmission of power, generated by a power source, to a drive wheel and interruption of the power to the drive wheel, to operate an engagement state of the clutch. The engine automatic control method includes: increasing the power generated by the power source when the clutch is engaged by the clutch operator; and changing a way of increasing the power on the basis of an operation mode of the clutch operator.

A seventh aspect of the invention provides an engine automatic control method using a clutch operator that engages or disengages a clutch, which changes between transmission of power, generated by a power source, to a drive wheel and interruption of the power to the drive wheel, to operate an engagement state of the clutch. The engine automatic control method includes: stopping or starting the power source on the basis of an operation of the clutch operator; and starting the power source on the basis of an operation mode in which the clutch operator is operated to engage the clutch during a stop of the power source.

An eighth aspect of the invention provides an engine automatic control method that stops or starts a power source during running of a vehicle on the basis of driving force required by a driver of the vehicle and that uses a clutch operator that operates an engagement state of a clutch, which changes transmission of power, generated by the power source, to a drive wheel and interruption of the power to the drive wheel, and an accelerator operator that adjusts the power generated by the power source. The engine automatic control method includes: selecting starting the power source or keeping the power source stopped on the basis of an operation state of the accelerator operator after the clutch operator has begun to be returned during a stop of the power source.

The engine automatic control system and engine automatic control method according to the aspects of the invention are advantageously able to achieve both improvement in fuel economy during vehicle driving and appropriate running control along a driver's intention. In addition, the engine automatic control system and engine automatic control method according to the aspects of the invention are advantageously able to achieve both improvement in fuel economy by stopping the engine during vehicle driving and appropriate start control along a driver's intention.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of a vehicle that includes an automatic control system according to an embodiment;

FIG. 2 is a detailed view of a detector that detects the operation state of a clutch pedal;

FIG. 3 is a flowchart that shows the schematic procedure of the automatic control system according to the embodiment;

FIG. 4 is a flowchart that shows the schematic procedure in the case where an upper switch and a lower switch are used to determine an intention of start;

FIG. 5 is a view that illustrates the case where a driver's intention is determined on the basis of a period of time during which the stroke of a clutch pedal changes;

FIG. 6 is a flowchart that shows the schematic procedure in the case where a clutch stroke sensor is used to determine an intention of start;

FIG. 7 is a view that illustrates the case where a driver's intention is determined on the basis of a variation speed at which the stroke of the clutch pedal varies;

FIG. 8 is a flowchart that shows the schematic procedure in the case where an intention of start is determined on the basis of a variation in stroke within a half-clutch range;

FIG. 9 is a view that illustrates the case where a driver's intention is determined on the basis of a variation in stroke within the half-clutch range; and

FIG. 10 is a flowchart that shows the schematic procedure in the case where an intention of start is determined on the basis of the operation state of the clutch pedal and the operation state of an accelerator pedal.

### DETAILED DESCRIPTION OF EMBODIMENTS

Hereinafter, an embodiment of an engine automatic control system according to the aspect of the invention will be described in details with reference to the accompanying drawings. Note that the aspect of the invention is not limited by this embodiment. In addition, components in the following embodiment include ones that are easily replaceable by a person skilled in the art or substantially equivalent ones.

### Embodiment

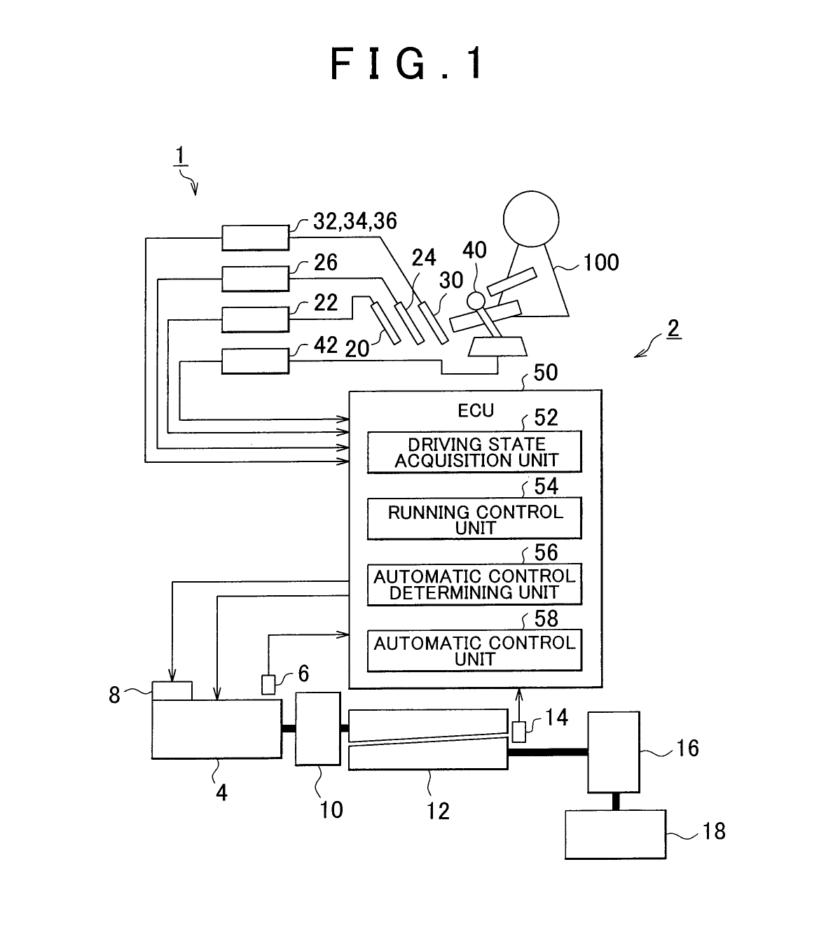

FIG. 1 is a schematic diagram of a vehicle that includes an automatic control system according to the embodiment. As shown in the drawing, the vehicle 1 that includes the automatic control system 2 for an engine 4 according to the present embodiment is provided with the engine 4. The engine 4 is an internal combustion engine and serves as a power source during running. The engine 4 is coupled to a step-gear transmission 12 via a clutch 10. In addition, the transmission 12 is connected to a final reduction gear 16 via a power transmission path. The final reduction gear 16 is coupled to a drive wheel 18 via a drive shaft. When the clutch 10 is engaged or disengaged, the clutch 10 is able to change between transmission of power, generated by the engine 4, to the drive wheel 18 and interruption of the power to the drive wheel 18. In addition, an engine rotational speed sensor 6 is provided for the engine 4, and the rotational speed of the engine 4 during operation is detectable. The engine rotational speed sensor 6 is a rotational speed detector that detects the engine rotational speed. In addition, a vehicle speed sensor 14 is provided for the transmission 12. The vehicle speed sensor 14 is a vehicle speed detector that detects the rotational speed of an output-side rotor, such as an output shaft, to thereby detect the vehicle speed.

In addition, a starter 8 is provided for the engine 4. The starter 8 serves as an internal combustion engine starter. The starter 8 is able to start the engine 4 by inputting rotational torque to the crankshaft (not shown) of the engine 4 when the engine 4 is stopped. The starter 8 is formed of an electric motor and a power transmission mechanism. The electric motor operates on electricity supplied from a battery (not shown). The battery is mounted on the vehicle 1 as a power supply. The power transmission mechanism transmits power, generated by the electric motor, to the engine 4. The starter 8 starts the engine 4 in such a manner that the electric motor operates on electricity from the battery and power generated by the electric motor is transmitted from the power transmission mechanism to the crankshaft of the engine 4 being stopped to rotate the crankshaft.

In addition, an accelerator pedal 20, a brake pedal 24 and a clutch pedal 30 are provided near the driver seat of the vehicle 1. The accelerator pedal 20 serves as an accelerator operator. The accelerator pedal 20 is able to adjust power generated by the engine 4, and is operated to adjust driving force. The brake pedal 24 serves as a braking operator. The brake pedal 24 is operated to generate braking force by a braking device (not shown) of the vehicle 1. The clutch pedal 30 serves as a clutch operator. The clutch pedal 30 engages or disengages the clutch 10 to operate the engagement state of the clutch 10. Furthermore, a shift lever 40 is provided near the driver seat. The shift lever 40 is able to select any one of a plurality of gears of the transmission 12, and is also able to select a neutral position at which none of gears is selected.

In addition, the operation states of the thus provided pedals and shift lever 40 each are detectable by driving operation detectors. Specifically, the operation state of the accelerator pedal 20 is detectable by an accelerator stroke sensor 22 that detects the degree of depression of the accelerator pedal 20, the operation state of the brake pedal 24 is detectable by a brake stroke sensor 26 that detects the degree of depression of the brake pedal 24, and the operation state of the clutch pedal 30 is detectable by a clutch stroke sensor 32 that detects the degree of depression of the clutch pedal 30. Similarly, the shift lever 40 is provided so that the operation state of the shift lever 40, that is, the selected gear or neutral position of the transmission 12, selected by the shift lever 40, is detectable by a shift sensor 42.

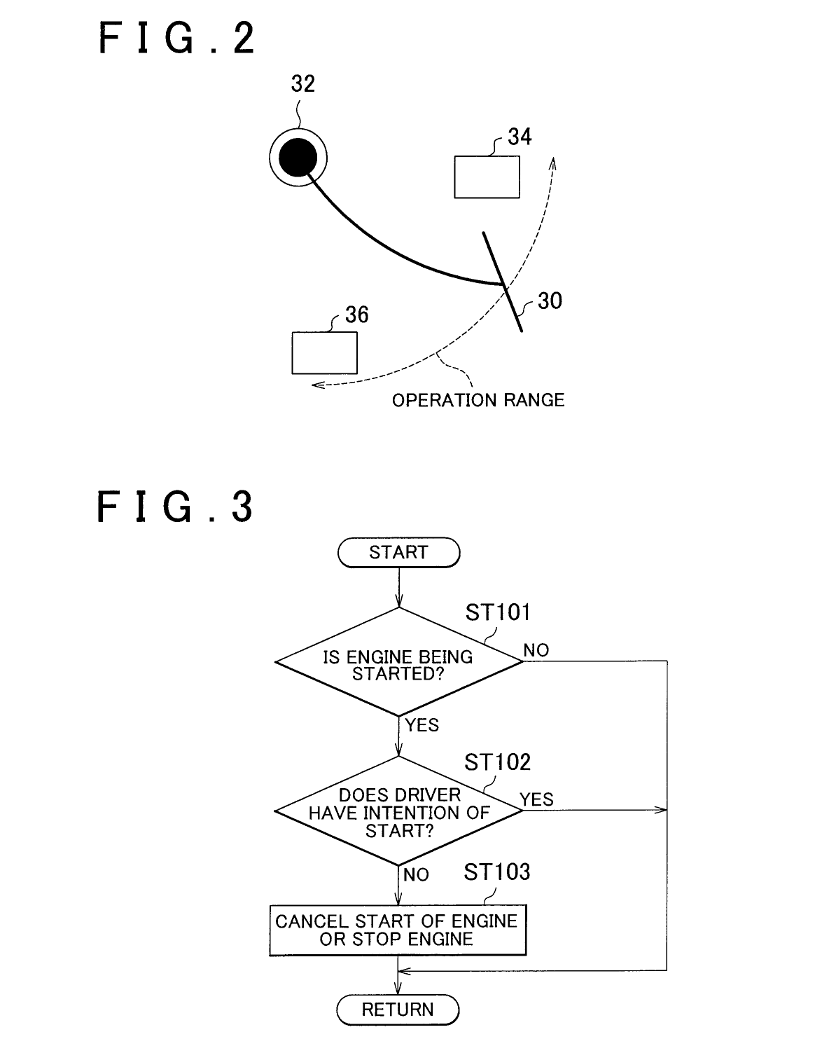

FIG. 2 is a detailed view of a detector that detects the operation state of the clutch pedal. Furthermore, an operation range end switch is provided as the detector that detects the operation state of the clutch pedal 30. The operation range end switch serves as an operation range end detector. The operation range end switch detects that the clutch pedal 30 is located at any one of ends of the operation range within which the clutch pedal 30 is operated. Specifically, a clutch upper switch 34 and a clutch lower switch 36 are provided as the operation range end switch. The clutch upper switch 34 detects whether the clutch pedal 30 is located at a return-side end of the clutch pedal 30 within the operation range of the clutch pedal 30. The clutch lower switch 36 detects whether the clutch pedal 30 is located at a depressing-side end of the clutch pedal 30 within the operation range of the clutch pedal 30.

The thus provided engine 4 and devices are mounted on the vehicle 1 and are connected to an electronic control unit (ECU) 50 that controls components of the vehicle 1. Similarly, the sensors and switches, such as the engine rotational speed sensor 6, the vehicle speed sensor 14, the accelerator stroke sensor 22, the brake stroke sensor 26, the clutch stroke sensor 32, the clutch upper switch 34, the clutch lower switch 36 and the shift sensor 42, are also connected to the ECU 50. By so doing, the components of the vehicle 1 are controlled by the ECU 50 and operated on the basis of the results detected by the sensors. For example, the engine 4 operates in such a manner that the intake air flow rate, the fuel injection amount of an injector (not shown) and the ignition timing are controlled on the basis of the operation amount of the accelerator pedal 20, detected by the accelerator stroke sensor 22, the engine rotational speed detected by the engine rotational speed sensor 6, the engine coolant temperature, and the like.

In addition, the vehicle 1 is able to carry out not only such normal running control but also, for example, automatic stop that the operation of the engine 4 is automatically stopped during a temporal stop of the vehicle 1, such as when the vehicle 1 stops at a traffic light during driving. In addition, when the engine 4 has been automatically stopped, the vehicle 1 is able to carry out automatic start that the engine is automatically restarted in response to a driver's start request. These automatic stop and automatic start may be carried out in such a manner that the engine 4, and the like, are controlled by the ECU 50.

The hardware configuration of the ECU 50 that is able to execute such various controls has a known configuration that includes a processing unit having a central processing unit (CPU), and the like, a storage unit, such as a random access memory (RAM), and the like, so the description thereof is omitted.

In addition, the sensors, such as the accelerator stroke sensor 22, the brake stroke sensor 26, the clutch stroke sensor 32 and the shift sensor 42, that detect the states of the operators of the vehicle 1 and the sensors, such as the engine rotational speed sensor 6 and the vehicle speed sensor 14, that detect the running condition of the vehicle 1 are connected to the processing unit of the thus provided ECU 50. The processing unit of the ECU 50 includes a driving state acquisition unit 52, a running control unit 54, an automatic control determining unit 56 and an automatic control unit 58. On the basis of the results detected by these sensors, the driving state acquisition unit 52 acquires the state of driving operation made by a driver 100 and the running condition of the vehicle 1, the running control unit 54 executes running control over the vehicle 1, such as control over the engine 4, the automatic control determining unit 56 makes various determinations when the engine 4 is automatically stopped or automatically started on the basis of the driving operation, and the like, acquired by the driving state acquisition unit 52, and the automatic control unit 58 controls automatic stop and automatic start of the engine 4.

The automatic control system 2 according to this embodiment is formed of the thus described configuration, and the operation of the automatic control system 2 will be described below. When the vehicle 1 is running, the accelerator operation amount, which is the operation amount of the accelerator pedal 20 operated by the driver 100, is detected by the accelerator stroke sensor 22, and the detected result is acquired by the driving state acquisition unit 52 of the ECU 50. The accelerator operation amount acquired by the driving state acquisition unit 52 is transmitted to the running control unit 54 of the ECU 50.

The running control unit 54 controls the engine 4 on the basis of the accelerator operation amount acquired by the driving state acquisition unit 52 and the running condition of the vehicle 1, acquired by the other sensors, to cause the engine 4 to generate power required by the driver 100. At this time, the running control unit 54 executes driving control while detecting the operation state of the engine 4 on the basis of the result detected by the engine rotational speed sensor 6, and the like. Power generated by the engine 4 is transmitted to the drive wheel 18 via the transmission 12 and the final reduction gear 16 to cause the drive wheel 18 to generate driving force.

In addition, when the vehicle 1 is running, the gear of the transmission 12 is shifted so that the speed ratio of the transmission 12 is suitable for a vehicle speed. The gear shift is performed in such a manner that the driver 100 operates the shift lever 40 to select any one of the gears.

A gear is selected by operating the shift lever 40 in this way, and, when shift operation is conducted while the vehicle 1 is running, the clutch pedal 30 is also operated. That is, when the gear is shifted while the vehicle 1 is running, the driver 100 depresses the clutch pedal 30 to disengage the clutch 10, and then the shift lever 40 is operated in a state where power transmission is interrupted between the engine 4 and the transmission 12. After shift operation is complete, the clutch pedal 30 is returned to engage the clutch 10, so power generated by the engine 4 is transmitted to the transmission 12. By so doing, the speed ratio with respect to the rotational speed of the engine 4 changes before and after shifting, and power generated by the engine 4 is transmitted to the drive wheel 18. When the driver 100 conducts these driving operations, the vehicle 1 runs while generating driving force required by the driver 100.

In addition, the automatic control system 2 according to the present embodiment is able to carry out automatic stop and automatic start of the engine 4 on the basis of the running condition of the vehicle 1 and the state of driving operation made by the driver 100, and, for example, the operation state of the clutch pedal 30 is used as the state of driving operation when these automatic stop and automatic start are carried out. That is, the automatic control system 2 according to the present embodiment is provided so as to be able to stop and start the engine 4 on the basis of an operation of the clutch pedal 30.

Between these automatic stop and automatic start, automatic stop will be described first. When it may be interpreted that driving force is not required by the driver 100, that is, the automatic stop condition of the engine 4 is satisfied, the vehicle 1 stops the operation of the engine 4. The automatic stop of the engine 4 is carried out in such a manner that the driving operation of the driver 100, acquired by the driving state acquisition unit 52 of the ECU 50, is determined by the automatic control determining unit 56 of the ECU 50 and then a predetermined condition that it may be interpreted that driving force is not required by the driver 100 is satisfied.

The automatic stop condition may be, for example, satisfied when the vehicle speed is zero, the shift lever 40 is placed at a neutral position and, furthermore, the clutch 10 is engaged, that is, the clutch pedal 30 is returned. When the automatic control determining unit 56 determines that the driving state acquired by the driving state acquisition unit 52 satisfies the automatic stop condition, the running control unit 54 executes stop control over the engine 4 for cutting fuel to the engine 4, or the like, to thereby automatically stop the engine 4.

When the vehicle 1 satisfies the automatic stop condition, the engine 4 is stopped in this way to reduce fuel consumption and reduce emissions of exhaust gas. When the driver 100 requires driving force and conducts driving operation by which it may be interpreted that the driver 100 has an intention of starting the vehicle 1 in a state where the engine 4 is stopped, the engine 4 is restarted. When the engine 4 is restarted, the engine 4 is started on the basis of an operation mode in which the clutch pedal 30 is operated to engage the clutch 10 during a stop of the engine 4.

The automatic start of the engine 4 will be described in detail. Even in a state where the engine 4 is stopped, the driving state acquisition unit 52 continuously acquires the driving state of the vehicle 1. The automatic control determining unit 56 determines whether driving force is required by the driver 100 on the basis of the operation states of the clutch pedal 30, and the like, acquired by the driving state acquisition unit 52 in this way, and, when it may be interpreted that driving force is required by the driver 100, determines to carry out automatic start of the engine 4.

The automatic start condition of the engine 4 may be, for example, satisfied when the clutch pedal 30 is depressed and the shift lever 40 is placed at a position other than the neutral position. When the automatic control determining unit 56 determines that the driving state acquired by the driving state acquisition unit 52 satisfies the automatic start condition, the running control unit 54 operates the starter 8 to start the engine 4.

The timing at which the engine 4 is automatically started will be described. When it is attempted to, for example, reduce fuel consumption, the operating time of the engine 4 is desirably short as much as possible. Therefore, when the engine 4 is automatically started, the timing at which the engine 4 is actually started is desirably later as much as possible. Thus, when the engine 4 is automatically started in a state where the clutch pedal 30 is depressed and the shift lever 40 is placed at a position other than the neutral position, the engine 4 is started at the time when the depressed clutch pedal 30 is returned.

The engine 4 is started by operating the starter 8. When the engine 4 is automatically started, the running control unit 54 controls the starter 8 and operates the starter 8 at the timing at which the clutch pedal 30 is returned. By so doing, power generated by the starter 8 is transmitted to the crankshaft of the engine 4, and then the crankshaft rotates. Furthermore, fuel supply control, ignition control, and the like, are executed over the engine 4 in synchronization with these controls to thereby automatically start the engine 4.

Here, automatic start of the engine 4 is carried out when the driving operation of the driver 100 satisfies the predetermined condition in this way; however, even when the driver 100 has no intention of starting the vehicle 1, the automatic start condition may possibly be satisfied when the vehicle 1 is parked or through erroneous operation. For example, in the case where the engine 4 is started at the timing at which the clutch pedal 30 is returned, when a driver's step is missed on the depressed clutch pedal 30 or when the clutch pedal 30 is returned in a state where the gear of the transmission 12 is shifted to a low gear in order to reliably stop the vehicle 1 when the vehicle 1 is parked, the automatic start condition may possibly be satisfied. In this case, irrespective of an intention of the driver 100, the engine 4 is started. Therefore, in the automatic control system 2 according to the present embodiment, when the engine 4 is automatically started, an intention of start of the driver 100 is determined, and then start control is executed.

FIG. 3 is a flowchart that shows the schematic procedure of the automatic control system according to the embodiment. Next, a control method for the automatic control system 2 according to the present embodiment, that is, the schematic procedure of the automatic control system 2, will be described. Note that the following process is a procedure used when an intention of the driver 100 is interpreted at the time when automatic start control of the engine 4 is executed, and the following process is called and executed at predetermined intervals when the components are controlled during driving of the vehicle 1.

When the engine 4 is started in consideration of an intention of the driver 100 at the time of an automatic start of the engine 4, first, it is determined whether the engine 4 is being started (step ST101). This determination is made by the automatic control determining unit 56 of the ECU 50. When the engine 4 is started, the running control unit 54 of the ECU 50 controls the starter 8 and the engine 4 to start the engine 4. When it is determined whether the engine 4 is being started, it is determined in such a manner that the state of control executed by the running control unit 54 is acquired by the automatic control determining unit 56. When it is determined that the engine 4 is not being started (No in step ST101), the process exits from the procedure.

In contrast to this, when it is determined that the engine 4 is being started (Yes in step ST101), it is determined whether the driver 100 has an intention of start (step ST102). This determination is made by the automatic control determining unit 56 on the basis of the states detected by the sensors and acquired by the driving state acquisition unit 52. That is, the automatic control determining unit 56 interprets the results detected by the sensors using the predetermined condition set in order to determine whether the driver 100 has an intention of start to thereby determine whether the driver 100 has an intention of start. When it is determined that the driver 100 has an intention of start (Yes in step ST102), the process exits from the procedure.

In contrast to this, when it is determined that the driver 100 has no intention of start (No in step ST102), start of the engine 4 is cancelled or the engine 4 is stopped (step ST103). That is, when the starter 8 is operated and the engine 4 is being started, the starter 8 is stopped to cancel the start of the engine 4. When the engine 4 is automatically started and has begun its operation, the operation is stopped. After a start of the engine 4 is cancelled or the engine 4 is stopped, the process exits from the procedure.

When the engine 4 is automatically started, start of the engine 4 is controlled by determining whether the driver 100 has an intention of start in this way to thereby prevent an automatic start in the case where the driver 100 has no intention of start and the automatic start condition is satisfied because of when the vehicle 1 is parked, through erroneous operation, or the like. Next, a specific determining method in the case where it is determined whether the driver 100 has an intention of start will be described.

An intention of start may be determined using the result detected by the clutch stroke sensor 32 or using the results detected by the clutch upper switch 34 and the clutch lower switch 36. First, the case where an intention of start is determined using the results detected by the clutch upper switch (hereinafter, referred to as upper switch) 34 and the clutch lower switch (hereinafter, referred to as lower switch) 36 will be described.

These upper switch 34 and lower switch 36 are able to detect whether the clutch pedal 30 is placed at any one of the ends of the operation range. Specifically, the upper switch 34 detects whether the clutch pedal 30 is placed at the return-side end within the operation range of the clutch pedal 30; whereas the lower switch 36 detects whether the clutch pedal 30 is placed at the depressing-side end within the operation range. That is, the upper switch 34 detects whether the clutch pedal 30 is fully returned, and the lower switch 36 detects whether the clutch pedal 30 is fully depressed.

In addition, urging force toward a side opposite to a depressing side is applied to the clutch pedal 30 by an urging device (not shown), such as a spring. When no external force, such as depressing force of the driver 100, is applied, the clutch pedal 30 is placed at an end opposite to the depressing side by the urging force of the urging device. Therefore, in the case where the clutch pedal 30 is depressed in order to automatically start the engine 4 after an automatic stop of the engine 4, when the driver 100 has no intention of starting the vehicle 1 and the clutch pedal 30 is returned at a stroke when the vehicle 1 is parked or a driver's step is missed on the clutch pedal 30 through erroneous operation, the clutch pedal 30 returns to the return-side end in a short period of time by the urging force of the urging device.

Therefore, when the upper switch 34 and the lower switch 36 are used to determine an intention of start, it is determined on the basis of a period of time from when the clutch pedal 30 is not detected by the lower switch 36 in a state where the clutch pedal 30 placed at the depressing-side end has been detected by the lower switch 36 till then to when the clutch pedal 30 is detected by the upper switch 34. Next, the procedure in the case where those upper switch 34 and lower switch 36 are used to determine an intention of start will be described.

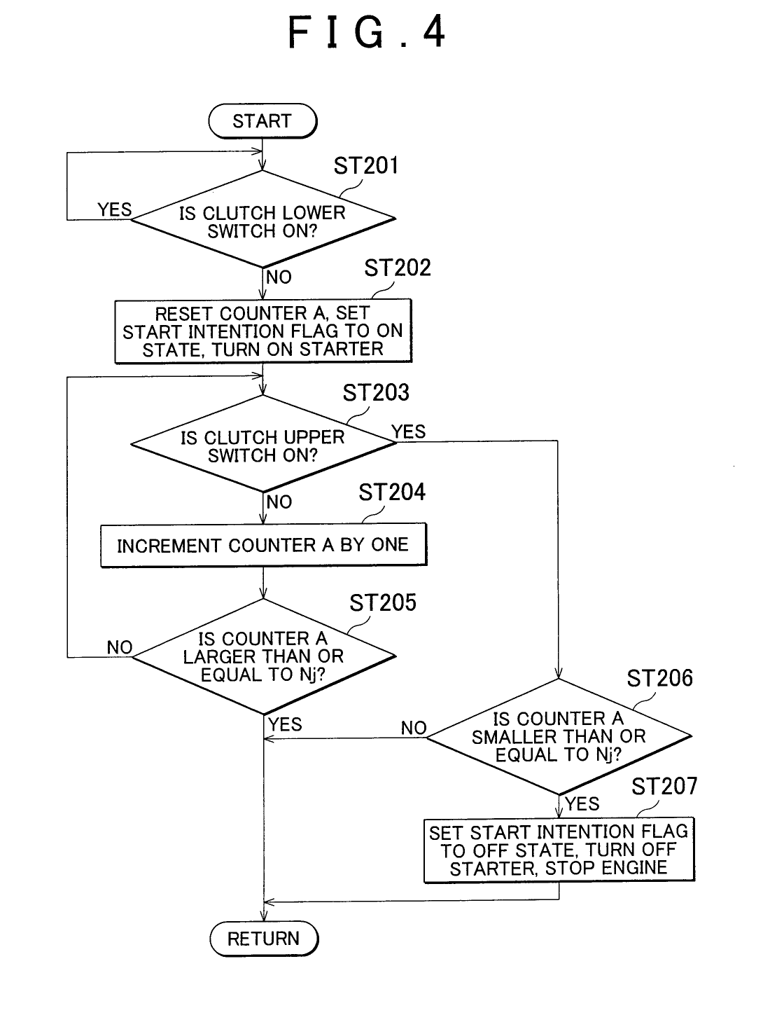

FIG. 4 is a flowchart that shows the schematic procedure in the case where the upper switch and the lower switch are used to determine an intention of start. When the upper switch 34 and the lower switch 36 are used to determine an intention of start of the driver 100, first, it is determined whether the lower switch 36 is on (step ST201). This determination is made by the automatic control determining unit 56 on the basis of the state of the lower switch 36, acquired by the driving state acquisition unit 52. The automatic control determining unit 56 determines whether the lower switch 36 has detected the clutch pedal 30, that is, whether the lower switch 36 is on, on the basis of the output state of the lower switch 36, acquired by the driving state acquisition unit 52. When it is determined that the lower switch 36 is on (Yes in step ST201), that is, when the state where the clutch pedal 30 is depressed has been detected, the lower switch 36 continues to detect the clutch pedal 30.

In contrast to this, when it is determined that the lower switch 36 is not on (No in step ST201), that is, when it is determined that the lower switch 36 is off, a counter A is reset, a start intention flag is set to an on state, and the starter 8 is turned on (step ST202). The counter A is set as a counter that indicates an elapsed time from when the lower switch 36 is turned off, and is used so that a value increases as a time elapses from when the lower switch 36 is turned off. In addition, the start intention flag indicates an intention of start of the driver 100. The start intention flag is set to an on state when it is determined that the driver 100 has an intention of start; whereas the start intention flag is set to an off state when it is determined that the driver 100 has no intention of start.

When it is determined that the lower switch 36 is off, the automatic control unit 58 of the ECU 50 resets the thus set counter A, and sets the start intention flag to an on state. In addition, when it is determined that the lower switch 36 is off, the automatic control unit 58 transmits a control signal that turns on the starter 8 to the running control unit 54 to cause the running control unit 54 to operate the starter 8.

Subsequently, it is determined whether the upper switch 34 is on (step ST203). This determination is made by the automatic control determining unit 56 on the basis of the state of the upper switch 34, acquired by the driving state acquisition unit 52. As in the case where the on/off state of the lower switch 36 is detected, the automatic control determining unit 56 determines whether the upper switch 34 is on on the basis of the output state of the upper switch 34, acquired by the driving state acquisition unit 52.

When the automatic control determining unit 56 determines that the upper switch 34 is not on (No in step ST203), that is, when it is determined that the upper switch 34 is off, the counter A is incremented by 1 (step ST204). That is, when the depressed clutch pedal 30 is not fully returned, the automatic control unit 58 adds one to the counter A.

After that, it is determined whether the counter A is larger than or equal to a predetermined determination value Nj (step ST205). This determination is made by the automatic control determining unit 56. In addition, the determination value Nj is preset as a determination value that is used when it is determined whether the driver 100 has an intention of starting the vehicle 1 on the basis of a period of time from when the clutch pedal 30 is placed at the depressing-side end of the operation range of the clutch pedal 30 to when the clutch pedal 30 reaches the return-side end at the time when the depressed clutch pedal 30 is returned, and is stored in the storage unit of the ECU 50. In other words, the determination value Nj is set as a reference time that is used when it is determined whether the driver 100 has an intention of starting the vehicle 1 on the basis of a period of time from when the clutch pedal 30 is placed at the depressing-side end to when the clutch pedal 30 reaches the return-side end.

The automatic control determining unit 56 compares the counter A computed by the automatic control unit 58 with the thus set determination value Nj to determine whether the counter A is larger than or equal to the determination value Nj. When it is determined that the counter A is not larger than or equal to the determination value Nj (No in step ST205), the process returns to step ST203, and then it is determined whether the upper switch 34 is on.

In contrast to this, when it is determined that the counter A is larger than or equal to the determination value Nj (Yes in step ST205), the process exits from the procedure. In this way, when a predetermined period of time elapses from the time point at which the clutch pedal 30 begins to return from the depressing-side end of the operation range of the clutch pedal 30 before the clutch pedal 30 reaches the return-side end of the operation range, that is, when the counter A becomes larger than or equal to the determination value Nj before the clutch pedal 30 reaches the return-side end, the process exits from the procedure.

In addition, in contrast to this, when the automatic control determining unit 56 determines that the upper switch 34 is on (Yes in step ST203), the automatic control determining unit 56 determines whether the counter A is smaller than or equal to the determination value Nj at that time point (step ST206). That is, the automatic control determining unit 56 determines whether the counter A at the time point at which the clutch pedal 30 has reached the return-side end of the operation range of the clutch pedal 30 is smaller than or equal to the determination value Nj.

When it is determined that the counter A is not smaller than or equal to the determination value Nj (No in step ST206), that is, when the counter A is larger than the determination value Nj and a period of time from when the depressed clutch pedal 30 is placed at the depressing-side end of the operation range to when the clutch pedal 30 reaches the return-side end is longer than a period of time by which it may be determined that the driver 100 has an intention of starting the vehicle 1, the process exits from the procedure.

In contrast to this, when it is determined that the counter A is smaller than or equal to the determination value Nj (Yes in step ST206), the start intention flag is set to an off state, the starter 8 is turned off, and the engine 4 is stopped (step ST207). That is, the automatic control unit 58 changes the start intention flag to an off state, the automatic control unit 58 transmits a control signal for turning off the starter 8 to the running control unit 54, and the running control unit 54 stops the starter 8.

Furthermore, the automatic control unit 58 transmits a control signal for stopping the engine 4 to the running control unit 54 to stop supply of fuel, or the like, to the engine 4. By so doing, the engine 4 stops its operation because the starter 8 is stopped and supply of fuel is stopped or ignition is not performed, or start of the engine 4 is cancelled when the engine 4 is in process of being started.

That is, when a period of time from when the depressed clutch pedal 30 is placed at the depressing-side end of the operation range to when the clutch pedal 30 reaches the return-side end of the operation range is shorter than or equal to a period of time by which it may be determined that the driver 100 has an intention of starting the vehicle 1, it is determined that the driver 100 has no intention of starting the vehicle 1, and the engine 4 is stopped. In this way, when control for stopping the engine 4 is executed, the process exits from the procedure.

When the engine 4 is automatically started in the case where the engine 4 is stopped as a result of automatic stop control, the counter A that is added while the clutch pedal 30 is being returned is compared with the determination value Nj in this way to select starting the engine 4 or keeping the engine 4 stopped. In other words, when the clutch pedal 30 is operated to engage the clutch 10 during a stop of the engine 4, starting the engine 4 or keeping the engine 4 stopped is selected on the basis of an operation speed at which the clutch pedal 30 is operated to engage the clutch 10.

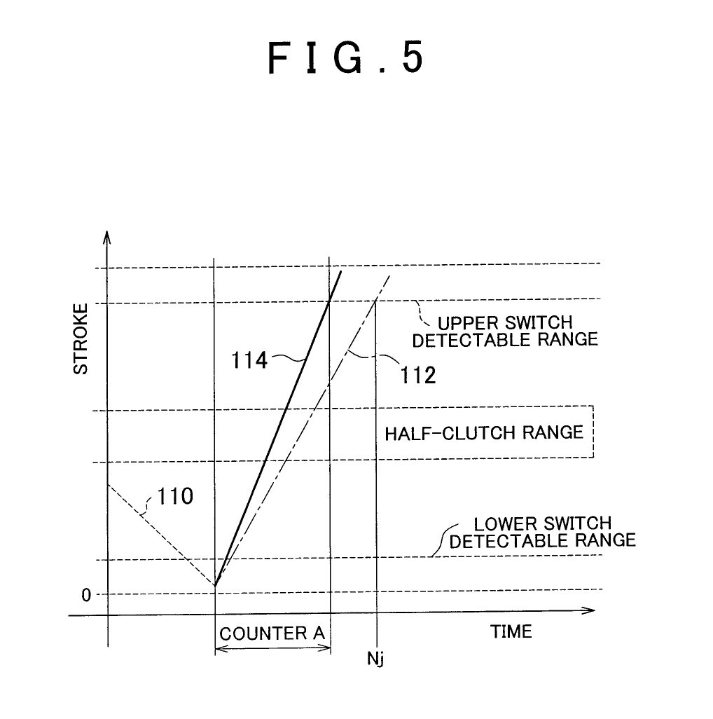

FIG. 5 is a view that illustrates the case where a driver's intention is determined on the basis of a period of time during which the stroke of the clutch pedal changes. When it is determined whether the driver 100 has an intention of starting the vehicle 1 during an automatic start of the engine 4, it may be determined on the basis of a period of time during which the clutch pedal 30 is operated as described above. Next, the correlation between a change in the stroke of the clutch pedal 30 and a period of time in the case where an intention of start is determined on the basis of the operation of the clutch pedal 30 will be described.

When the engine 4 is automatically started in a state where the engine 4 is stopped as a result of automatic stop control, the clutch pedal 30 is depressed. In this way, in the case where the clutch pedal 30 is depressed, when it is assumed that the stroke of the fully depressed state is zero, the stroke of the clutch pedal 30 reduces with a lapse of time as indicated by the depressing time 110 in FIG. 5.

When the engine 4 is automatically started, the clutch pedal 30 is fully depressed and is returned after the stroke becomes zero, so the stroke of the clutch pedal 30 increases with a lapse of time as indicated by the normal return time 112 in FIG. 5.

Here, the lower switch 36 detects that the clutch pedal 30 is placed at the depressing-side end of the operation range. The lower switch 36 detects the clutch pedal 30 not only when the clutch pedal 30 is placed exactly at the end of the operation range but also when the clutch pedal 30 is placed within a predetermined range near the end of the operation range, that is, a lower switch detectable range. Therefore, in the case where the clutch pedal 30 has begun to be returned from the depressed state, when the stroke falls within the lower switch detectable range, the clutch pedal 30 is detected by the lower switch 36, and, when the stroke is larger than the lower switch detectable range, the clutch pedal 30 is not detected by the lower switch 36. In the case where the engine 4 is automatically started, when the stroke of the clutch pedal 30 is larger than the lower switch detectable range in this way, the counter A begins to count, and the engine 4 is started.

In the case where the driver 100 returns the clutch pedal 30, when the stroke increases with a lapse of time as indicated by the normal return time 112, and then the clutch pedal 30 reaches near the return-side end of the operation range, the upper switch 34 detects the clutch pedal 30. The upper switch 34, as well as the lower switch 36, detects the clutch pedal 30 when the clutch pedal 30 is placed within an upper switch detectable range that is a predetermined range near the end of the operation range.

In the case where the engine 4 is automatically started, when the depressed clutch pedal 30 is returned, an intention of start of the driver 100 is determined on the basis of a period of time from when the clutch pedal 30 is no longer detected by the lower switch 36 to when the clutch pedal 30 is detected by the upper switch 34.

That is, the clutch pedal 30 is relatively slowly returned when the driver 100 has an intention of starting the vehicle 1, so, when the counter A at the time point when the upper switch 34 has detected the clutch pedal 30 is larger than the determination value Nj, it is determined that the driver 100 has an intention of starting the vehicle 1. In other words, at the normal return time 112, the counter A at the time point when the clutch pedal 30 has reached the upper switch detectable range is larger than the determination value Nj.

In contrast to this, when the clutch pedal 30 is returned at the time of parking, or the like, the return speed at which the clutch pedal 30 is returned is faster than the return speed at which the clutch pedal 30 is returned through normal driving operation of the driver 100. Therefore, a variation in the stroke of the clutch pedal 30 per unit time is larger than that at the normal return time 112 as indicated by the parking operation time 114 in FIG. 5. Therefore, at the parking operation time 114, the counter A at the time point when the clutch pedal 30 has reached the upper switch detectable range is smaller than the counter A at the normal return time 112, and is smaller than the determination value Nj. In this case, it is determined that the driver 100 has no intention of starting the vehicle 1, and automatic start of the engine 4 is stopped.

In the case where the engine 4 is automatically started, when the clutch pedal 30 is displaced toward a return side in this way, addition of the counter A is continued from when the clutch pedal 30 leaves from the lower switch detectable range to when the clutch pedal 30 reaches the upper switch detectable range, and the engine 4 is kept stopped when the counter A at the time point when the clutch pedal 30 has reached the upper switch detectable range is smaller than or equal to the determination value Nj. In other words, in the case where the clutch pedal 30 is operated to engage the clutch 10 during a stop of the engine 4, when a period of time from when it is detected that the clutch pedal 30 has left from the depressing-side end to when it is detected that the clutch pedal 30 has reached the return-side end is shorter than a predetermined reference time, the engine 4 is kept stopped.

The above described automatic control system 2 is able to stop and start the engine 4 on the basis of the operation of the clutch pedal 30, so the clutch pedal 30 is operated to stop the engine 4 to thereby make it possible to stop the engine 4 during driving of the vehicle 1. By so doing, it is possible to reduce the operating time of the engine 4 during driving of the vehicle 1, so fuel consumption may be reduced. In addition, when the engine 4 is stopped in this way, the engine 4 is started on the basis of an operation mode in which the clutch pedal 30 is operated to engage the clutch 10, so it is possible to reduce a start that is not intended by the driver 100. That is, not the engine 4 is simply started when the clutch pedal 30 is operated to engage the clutch 10 but the engine 4 is started on the basis of an operation mode of the clutch pedal 30 at the time when the clutch 10 is engaged, so the engine 4 may be started only in the case of an operation mode by which it may be determined that the driver 100 has an intention of starting the engine 4. By so doing, the engine 4 is not started when the driver 100 has no intention of starting the engine 4, and the engine 4 may be started only when the driver 100 has an intention of starting the engine 4. As a result, it is possible to achieve both improvement in fuel economy by stopping the engine 4 during driving of the vehicle 1 and appropriate start control along an intention of the driver 100.

In addition, when the engine 4 is automatically stopped, starting the engine 4 or keeping the engine 4 stopped is selected on the basis of an operation speed at which the clutch pedal 30 is operated to engage the clutch 10, so it is possible to appropriately change between a start and stop of the engine 4 on the basis of an intention of the driver 100 as to whether the engine 4 is started. That is, when the stopped vehicle 1 is started during driving of the vehicle 1, the clutch pedal 30 is generally slowly returned in order to gradually increase driving force; whereas, when the clutch pedal 30 is returned at a stroke during parking or a driver's step is missed on the clutch pedal 30 through erroneous operation, the clutch pedal 30 returns at a relatively fast moving speed. Therefore, by selecting starting the engine 4 or keeping the engine 4 stopped on the basis of the operation speed of the clutch pedal 30, it is possible to change start control over the engine 4 on the basis of an intention of the driver 100 as to whether the vehicle 1 is started. As a result, it is possible to further reliably execute appropriate start control along an intention of the driver 100.

In addition, the upper switch 34 and the lower switch 36 detect the fact the clutch pedal 30 is located at any one of the ends of the operation range within which the clutch pedal 30 is operated. Therefore, when the clutch pedal 30 is returned, the lower switch 36 is able to detect the fact that the clutch pedal 30 has left from the depressing-side end, and the upper switch 34 is able to detect the fact that the clutch pedal 30 has reached the return-side end. By so doing, during a stop of the engine 4, when the driver 100 operates the clutch pedal 30 to engage the clutch 10, a period of time from when the clutch pedal 30 leaves from the depressing-side end to when the clutch pedal 30 reaches the return-side end may be detected using the upper switch 34 and the lower switch 36, and the engine 4 is kept stopped when the detected period of time is shorter than the reference time. Thus, when the engine 4 is automatically started during a stop of the engine 4, it is possible to further reliably and easily select starting the engine 4 or keeping the engine 4 stopped on the basis of the operating speed of the clutch pedal 30. As a result, it is possible to further reliably execute appropriate start control along an intention of the driver 100.

Note that, in the above described automatic control system 2, the upper switch 34 and the lower switch 36 are used to detect the operating speed of the clutch pedal 30; instead, the operating speed of the clutch pedal 30 may be detected using another method. The operating speed of the clutch pedal 30 may be, for example, detected using the clutch stroke sensor 32.

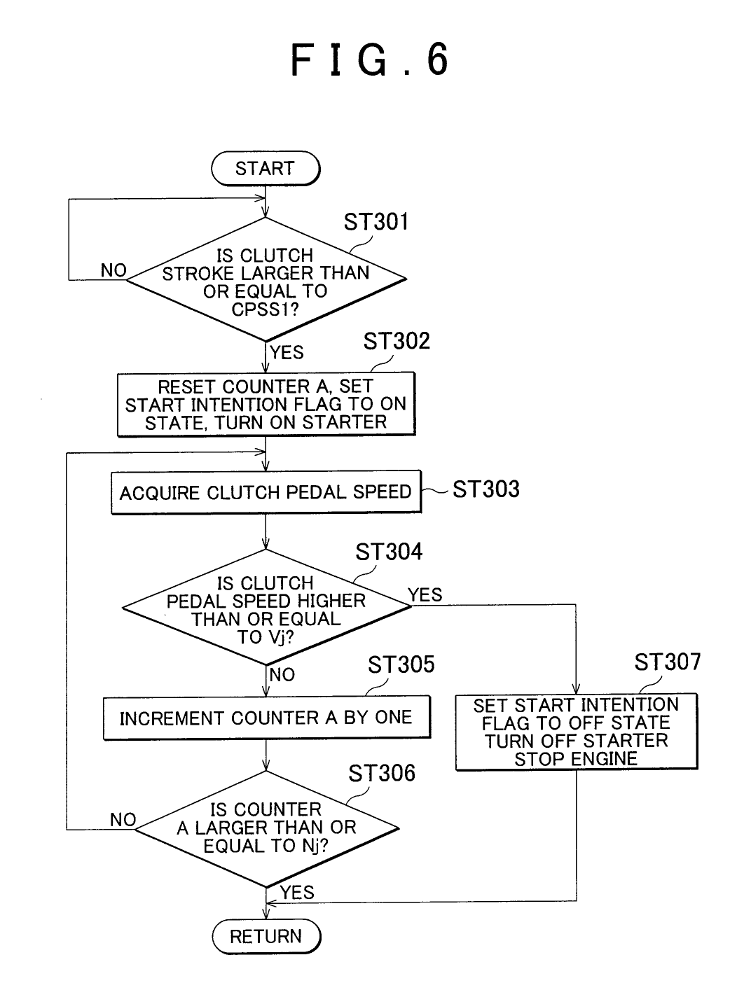

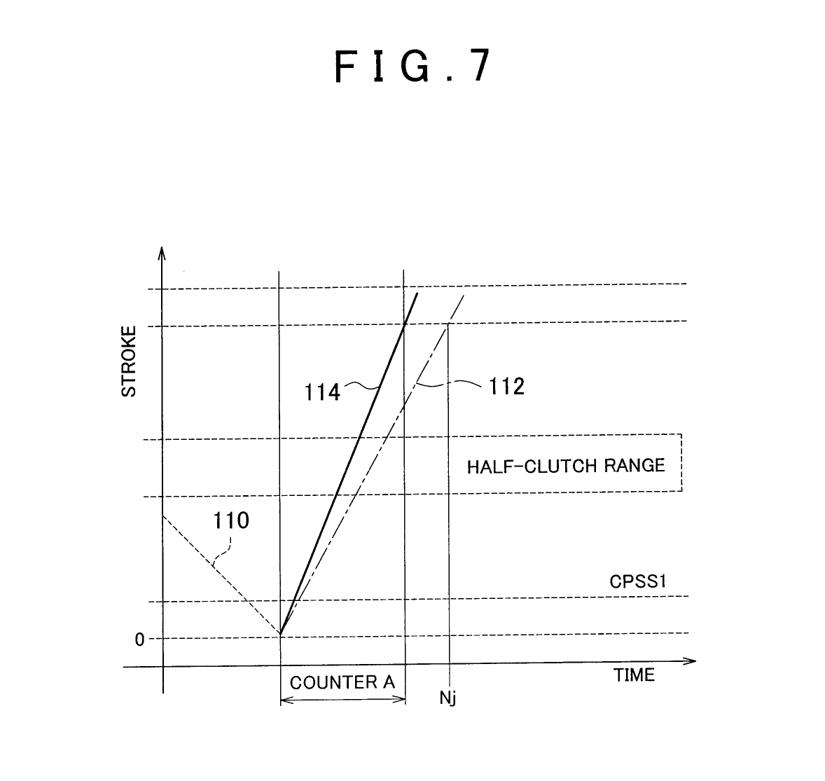

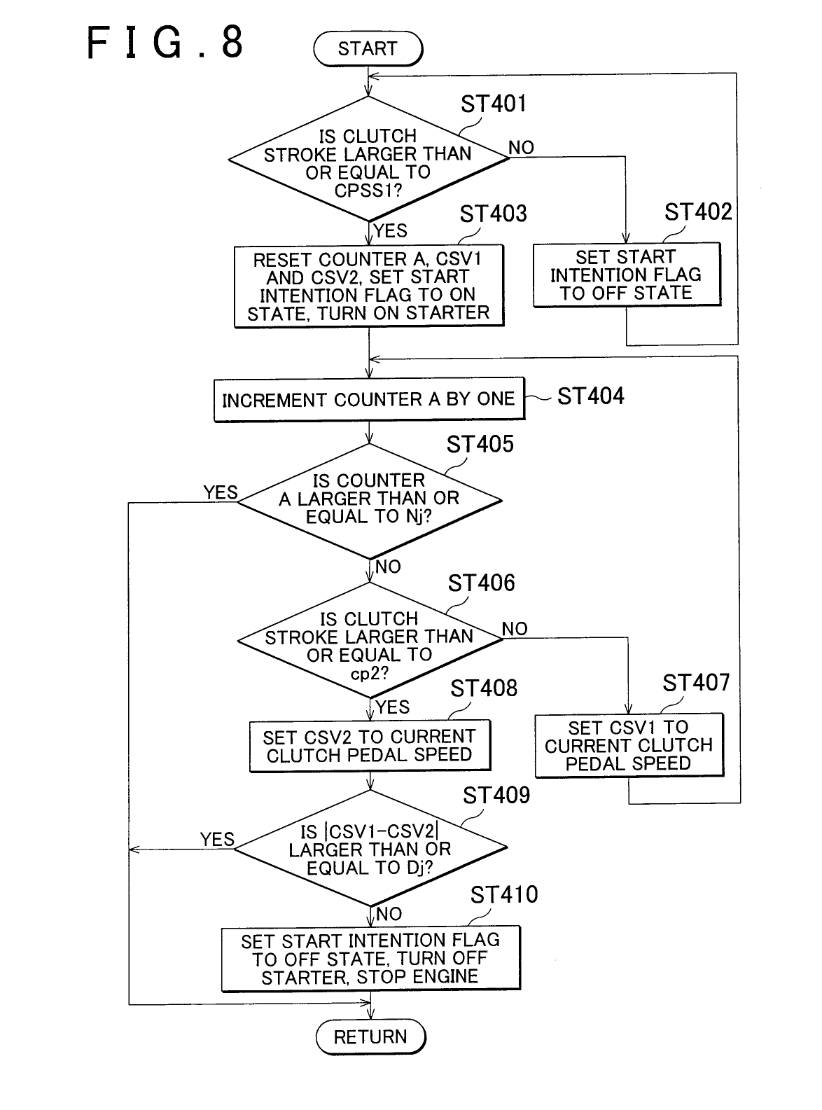

FIG. 6 is a flowchart that shows the schematic procedure in the case where the clutch stroke sensor is used to determine an intention of start. FIG. 7 is a view that illustrates the case where an intention of the driver is determined on the basis of a variation speed at which the stroke of the clutch pedal varies. When the clutch stroke sensor 32 is used to determine an intention of start of the driver 100, it is determined whether the clutch stroke is larger than or equal to CPSS1 (step ST301). This determination is made by the automatic control determining unit 56 on the basis of the state of the clutch stroke sensor 32, acquired by the driving state acquisition unit 52.

Note that CPSS1 (FIG. 7) used in this determination is a stroke at which it may be interpreted that the depressed clutch pedal 30 has begun to be returned within the operation range of the clutch pedal 30, that is, the stroke of the clutch pedal 30, and is set at a position slightly returned from the depressing-side end. In addition, CPSS1 is a stroke substantially equivalent to the stroke of the lower switch detectable range that is the range in which the clutch pedal 30 may be detected by the lower switch 36 within the operation range of the clutch pedal 30. CPSS1 is set in this way, and is stored in the storage unit of the ECU 50 in advance. The automatic control determining unit 56 compares the clutch stroke acquired by the driving state acquisition unit 52 from the result detected by the clutch stroke sensor 32 with CPSS1 stored in the storage unit, and determines whether the acquired clutch stroke is larger than or equal to CPSS1.

When it is determined that the clutch stroke is smaller than CPSS1 (No in step ST301), that is, when it is detected that the clutch pedal 30 has not begun to be returned, the clutch stroke sensor 32 continues to detect the Clutch stroke.

In contrast to this, when it is determined that the clutch stroke is larger than or equal to CPSS1 (Yes in step ST301), the counter A is reset, the start intention flag is set to an on state, and the starter 8 is turned on (step ST302). That is, the counter A is reset, the start intention flag is set to an on state, and the starter 8 is operated.

Subsequently, the clutch pedal speed is acquired (step ST303). The clutch pedal speed is acquired in such a manner that the result detected by the clutch stroke sensor 32 is continuously acquired by the driving state acquisition unit 52 and the clutch pedal speed is calculated by the driving state acquisition unit 52 on the basis of a variation per unit time in the clutch stroke detected by the clutch stroke sensor 32.

After that, it is determined whether the clutch pedal speed is higher than or equal to a predetermined determination speed Vj (step ST304). This determination is made by the automatic control determining unit 56. In addition, the determination speed Vj is preset as a determination speed when it is determined whether the driver 100 has an intention of starting the vehicle 1 on the basis of the speed of the clutch pedal 30 at which the depressed clutch pedal 30 is returned, and is stored in the storage unit of the ECU 50. The automatic control determining unit 56 compares the clutch pedal speed acquired by the driving state acquisition unit 52 with the thus set determination speed Vj, and determines whether the clutch pedal speed is higher than or equal to the determination speed Vj.

When it is determined that the clutch pedal speed is not higher than or equal to the determination speed Vj (No in step ST304), that is, when it is determined that the clutch pedal speed is lower than the determination speed Vj, the automatic control unit 58 increments the counter A by one (step ST305). That is, for example, as indicated by the normal return time 112 (FIG. 7), when a variation per unit time in the stroke of the clutch pedal 30 is relatively small, the counter A is incremented by one.

Subsequently, the automatic control determining unit 56 determines whether the counter A is larger than or equal to the determination value Nj (step ST306). When it is determined that the counter A is not larger than or equal to the determination value Nj (No in step ST306), the process returns to step ST303, and the clutch pedal speed is acquired. In contrast to this, when it is determined that the counter A is larger than or equal to the determination value Nj (Yes in step ST306), the process exits from the procedure.

In addition, in contrast, when the automatic control determining unit 56 determines that the clutch pedal speed is higher than or equal to the predetermined determination speed Vj (Yes in step ST304), the start intention flag is set to an off state, the starter 8 is turned off, and the engine 4 is stopped. (step ST307). That is, the automatic control unit 58 changes the start intention flag to an off state, the automatic control unit 58 transmits a control signal for turning off the starter 8 to the running control unit 54 to stop the starter 8, and, furthermore, the automatic control unit 58 transmits a control signal for stopping the engine 4 to the running control unit 54 to stop the engine 4.

That is, for example, as indicated by the parking operation time 114 (FIG. 7), when a variation per unit time in the stroke of the clutch pedal 30 is relatively large and the speed at which the clutch pedal 30 is returned is higher than or equal to the determination speed Vj used to determine an intention of starting the vehicle 1, it is determined that the driver 100 has no intention of starting the vehicle 1, and the engine 4 is stopped. In this way, when control for stopping the engine 4 is executed, the process exits from the procedure.

When the engine 4 is automatically started in the case where the engine 4 is stopped as a result of automatic stop control, the operating speed at which the clutch pedal 30 is returned is compared with the determination speed Vj in this way to select starting the engine 4 or keeping the engine 4 stopped. In this way, when the engine 4 is automatically started in the case where the engine 4 is stopped as a result of automatic stop control, the result detected by the clutch stroke sensor 32 is used when starting the engine 4 or keeping the engine 4 stopped is selected on the basis of the operating speed of the clutch pedal 30 to thereby make it possible to easily and accurately acquire the operating speed of the clutch pedal 30. As a result, it is possible to further easily and accurately execute appropriate start control along an intention of the driver 100.

In addition, when the engine 4 is automatically started, control may be changed on the basis of the operating speed within a predetermined operation range in the case where starting the engine 4 or keeping the engine 4 stopped is selected on the basis of the operating speed of the clutch pedal 30. For example, when the clutch pedal 30 is returned to engage the clutch 10 at the time when the stopped vehicle 1 is started, an operation in a half-clutch range that is an intermediate range within the operation range of the clutch pedal 30 is important, and the operation speed of the clutch pedal 30 is particularly slow in this half-clutch range. Therefore, an intention of start of the driver 100 of the vehicle 1 is interpreted on the basis of the return sped of the clutch pedal 30 in the half-clutch range to thereby make it possible to further appropriately interpret an intention of start.

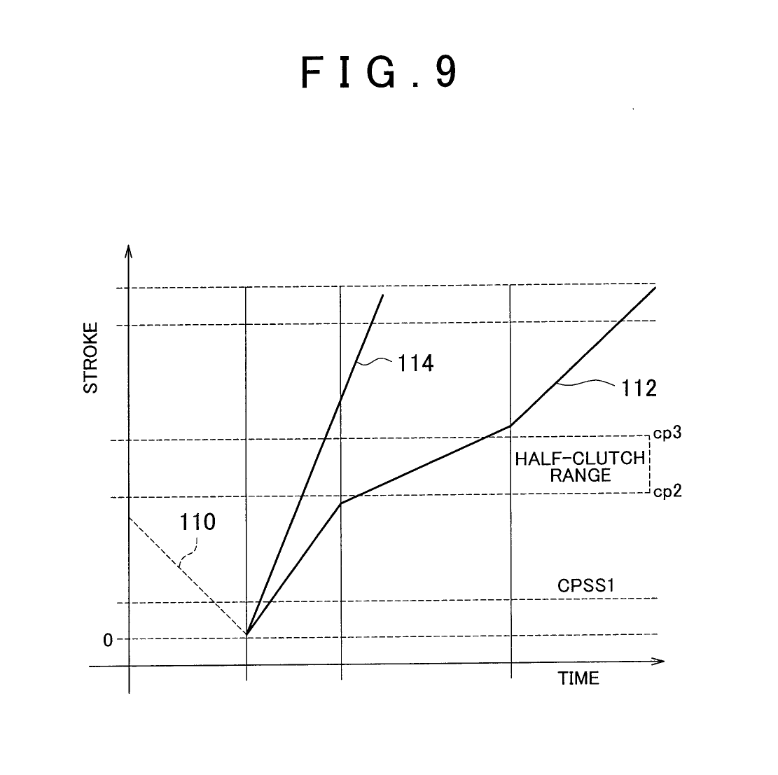

FIG. 8 is a flowchart that shows the schematic procedure in the case where an intention of start is determined on the basis of a variation in stroke within a half-clutch range. FIG. 9 is a view that illustrates the case where a driver's intention is determined on the basis of a variation in stroke within the half-clutch range. The procedure in the case where control is changed on the basis of the operating speed of the clutch pedal 30 within the half-clutch range in this way when the engine 4 is automatically started will be described. First, the automatic control determining unit 56 determines whether the clutch stroke is larger than or equal to CPSS1 (step ST401).

When it is determined that the clutch stroke is not larger than or equal to CPSS1 (No in step ST401), that is, when it is determined that the clutch stroke is smaller than CPSS1, the automatic control unit 58 changes the start intention flag to an off state (step ST402). When the start intention flag is changed to an off state, the clutch stroke is detected by the clutch stroke sensor 32, and determination as to whether the clutch stroke is larger than or equal to CPSS1 is continued.

In contrast to this, when it is determined that the clutch stroke is larger than or equal to CPSS1 (Yes in step ST401), the counter A, CSV1 and CSV2 are reset, the start intention flag is set to an on state, and the starter 8 is turned on (step ST403). CSV1 is the operating speed of the clutch pedal 30 before the clutch stroke reaches the half-clutch range when the depressed clutch pedal 30 is returned, and CSV2 is the operating speed of the clutch pedal 30 within the half-clutch range. That is, in the case where the clutch pedal 30 is returned, when the clutch stroke at which the half-clutch range begins is cp2 (FIG. 9) and the clutch stroke at which the half-clutch range ends is cp3 (FIG. 9), CSV1 is the operating speed of the clutch pedal 30 between CPSS1 and cp2, and CSV2 is the operating speed between cp2 and cp3. When it is determined that the clutch stroke is larger than or equal to CPSS1, CSV1, CSV2 and the counter A are reset, the start intention flag is set to an on state, and the starter 8 is operated.

Subsequently, the automatic control unit 58 increments the counter A by one (step ST404), and the automatic control determining unit 56 determines whether the counter A is larger than or equal to the determination value Nj (step ST405). When it is determined that the counter A is larger than or equal to the determination value Nj (Yes in step ST405), the process exits from the procedure.

In contrast to this, when it is determined that the counter A is not larger than or equal to the determination value Nj (No in step ST405), it is subsequently determined whether the clutch stroke is larger than or equal to cp2 (step ST406). This determination is made by the automatic control determining unit 56. In addition, cp2 used in this determination is stored in the storage unit of the ECU 50 in advance as the stroke at the time point when the half-clutch range begins at the time of returning the clutch pedal 30. The automatic control determining unit 56 compares cp2 stored in the storage unit in this way with the clutch stroke that is detected by the clutch stroke sensor 32 and that is acquired by the driving state acquisition unit 52, and determines whether the clutch stroke acquired by the driving state acquisition unit 52 is larger than or equal to cp2.

When it is determined that the clutch stroke is not larger than or equal to cp2 (No in step ST406), that is, when it is determined that the clutch stroke is smaller than cp2, set CSV1 to the current clutch pedal speed (step ST407). That is, the clutch pedal speed acquired by the driving state acquisition unit 52 on the basis of the result detected by the clutch stroke sensor 32 that continuously detects the stroke of the clutch pedal 30 is substituted into CSV1 to set CSV1 to the current clutch pedal speed. By so doing, the clutch pedal speed in a state where the clutch stroke is placed between CPSS1 and cp2 is substituted into CSV1. In this way, when CSV1 is set to the current clutch pedal speed, the process returns to step ST404, and the counter A is incremented by one.

In contrast to this, when it is determined that the clutch stroke is larger than or equal to cp2 (Yes in step ST406), CSV2 is set to the current clutch pedal speed (step ST408). In this computation as well, as in the case where CSV1 is set to the current clutch pedal speed in step ST407, the clutch pedal speed acquired by the driving state acquisition unit 52 is substituted into CSV2 to set CSV2 to the current clutch pedal speed. By so doing, the clutch pedal speed in a state where the clutch stroke is placed between cp2 and cp3 is substituted into CSV2.

Subsequently, it is determined whether |CVS1−CVS2 is larger than or equal to Dj (step ST409). In this determination, the automatic control determining unit 56 determines whether the absolute value of a value obtained by subtracting CVS2 from CVS1 is larger than or equal to a predetermined determination value Dj. Note that the determination value Dj used in this determination is preset as a determination value by which it is determined whether the driver 100 has an intention of starting the vehicle 1 on the basis of a difference in clutch pedal speed between before the clutch stroke enters the half-clutch range and after the clutch stroke enters the half-clutch range when the clutch pedal 30 is returned, and is stored in the storage unit of the ECU 50. The automatic control determining unit 56 compares the computed result of |CVS1−CVS2| with the thus set determination value Dj, and determines whether |CVS1−CVS2| is larger than or equal to the determination value Dj.

When it is determined that |CVS1−CVS2| is larger than or equal to Dj (Yes in step ST409), the process exits from the procedure. That is, while the clutch pedal 30 is returned, when the difference in clutch pedal speed between before the clutch stroke enters the half-clutch range and after the clutch stroke enters the half-clutch range is larger than or equal to a predetermined difference as indicated by the normal return time 112 (FIG. 9), it may be interpreted that the driver 100 is conducting driving operation while adjusting the clutch pedal 30 at a selected clutch pedal speed. Therefore, in such a case, it is determined that the driver 100 has an intention of starting the vehicle 1, and the process exits from the procedure.

In contrast to this, when it is determined that |CVS1−CVS2| is not larger than or equal to Dj (No in step ST409), that is, it is determined that |CVS1−CVS2| is smaller than the determination value Dj, the start intention flag is set to an off state, the starter 8 is turned off, and the engine 4 is stopped (step ST410). That is, the automatic control unit 58 changes the start intention flag to an off state, the automatic control unit 58 transmits a control signal for turning off the starter 8 to the running control unit 54 to stop the starter 8, and, furthermore, the automatic control unit 58 transmits a control signal for stopping the engine 4 to the running control unit 54 to stop the engine 4.

For example, when a variation in clutch pedal speed between before the clutch stroke enters the half-clutch range and after the clutch stroke enters the half-clutch range is small as indicated by the parking operation time 114 (FIG. 9) and the difference in clutch pedal speed is smaller than the determination value Dj used to determine an intention of starting the vehicle 1, it may be interpreted that the driver 100 is not adjusting the clutch pedal 30 at a selected clutch pedal speed. Therefore, in such a case, it is determined that the driver 100 has no intention of starting the vehicle 1, and the engine 4 is stopped. In this way, when control for stopping the engine 4 is executed, the process exits from the procedure.

When the engine 4 that is stopped as a result of automatic stop control is automatically started, the variation in clutch pedal speed between before and after the half-clutch range at the time of returning the clutch pedal 30 is compared with the determination value Dj in this way to select starting the engine 4 or keeping the engine 4 stopped. In this way, when the engine 4 is automatically started in the case where the engine 4 is stopped as a result of automatic stop control, at the time when starting the engine 4 or keeping the engine 4 stopped is selected on the basis of the operating speed of the clutch pedal 30, the variation in clutch pedal speed between before and after the half-clutch range that is the intermediate range within the operation range of the clutch pedal 30 is used to make it possible to further appropriately interpret an intention of the driver 100. As a result, it is possible to further reliably execute appropriate start control along an intention of the driver 100.

In addition, in the case where starting the engine 4 or keeping the engine 4 stopped is selected on the basis of the driving operation of the driver 100 when the engine 4 is automatically started, the operation state of an operator other than the clutch pedal 30 may also be used to change control. For example, when the stopped vehicle 1 is started, generally, the accelerator pedal 20 is operated to increase power generated by the engine 4 while returning the clutch pedal 30 to engage the clutch 10, so the operation state of the accelerator pedal 20 may also be used to change control at the time of an automatic start.

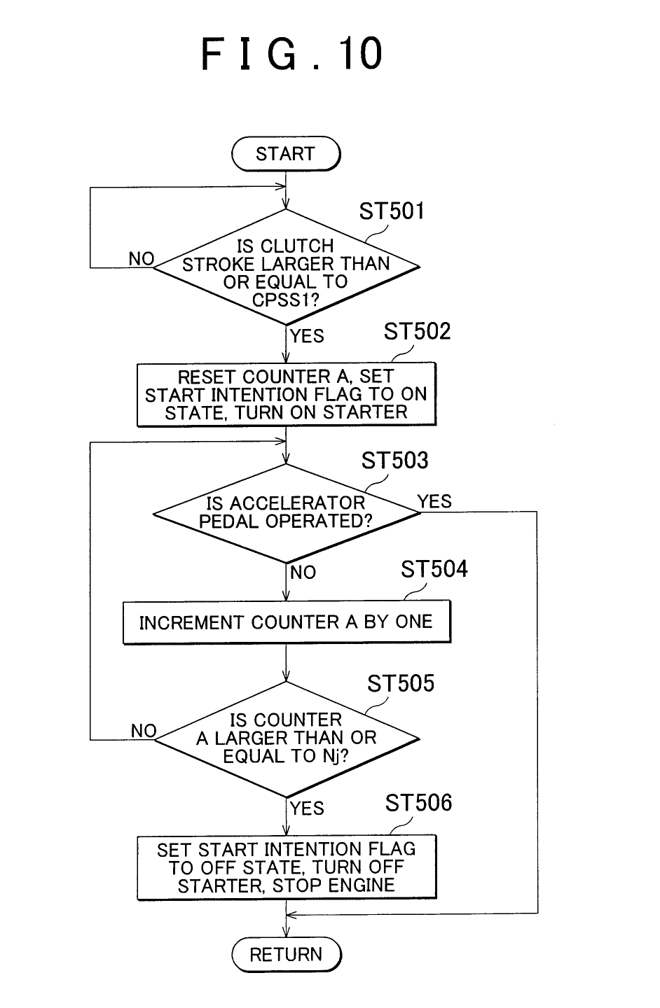

FIG. 10 is a flowchart that shows the schematic procedure in the case where an intention of start is determined on the basis of the operation state of the clutch pedal and the operation state of the accelerator pedal. The procedure in the case where the operation state of the accelerator pedal 20 is also used to change control in this way when the engine 4 is automatically started will be described. First, the automatic control determining unit 56 determines whether the clutch stroke is larger than or equal to CPSS1 (step ST501). When it is determined that the clutch stroke is smaller than CPSS1 (No in step ST501), detecting the clutch stroke is continued, and determination as to whether the clutch stroke is larger than or equal to CPSS1 is continued.

In contrast to this, when it is determined that the clutch stroke is larger than or equal to CPSS1 (Yes in step ST501), the counter A is reset, the start intention flag is set to an on state, and the starter 8 is turned on (step ST502).

Subsequently, it is determined whether the accelerator pedal 20 is operated (step ST503). The automatic control determining unit 56 makes this determination on the basis of the operation state of the accelerator pedal 20, acquired by the driving state acquisition unit 52. That is, the operation state of the accelerator pedal 20 is detected by the accelerator stroke sensor 22, and the driving state acquisition unit 52 acquires the result detected by the accelerator stroke sensor 22 to thereby acquire the operation state of the accelerator pedal 20. The automatic control determining unit 56 determines whether the accelerator pedal 20 is depressed, that is, whether the accelerator pedal 20 is operated, on the basis of the operation state of the accelerator pedal 20, acquired by the driving state acquisition unit 52 in this way.

When it is determined that the accelerator pedal 20 is operated (Yes in step ST503), the process exits from the procedure. That is, when the accelerator pedal 20 is operated, the driver 100 requires increasing power generated by the engine 4, and it may be determined that the driver 100 has an intention of starting the vehicle 1. Therefore, when it is determined that the accelerator pedal 20 is operated, it is determined that the driver 100 has an intention of starting the vehicle 1, and the process exits from the procedure.

In contrast to this, when it is determined that the accelerator pedal 20 is not operated (No in step ST503), the automatic control unit 58 subsequently increments the (counter A by one (step ST504), and the automatic control determining unit 56 determines whether the counter A is larger than or equal to the determination value Nj (step ST505). When it is determined that the counter A is not larger than or equal to the determination value Nj (No in step ST505), the process returns to step ST503, and it is determined whether the accelerator pedal 20 is operated.

In contrast to this, when it is determined that the counter A is larger than or equal to the determination value Nj (Yes in step ST505), the start intention flag is set to an off state, the starter 8 is turned off, and the engine 4 is stopped (step ST506). That is, the automatic control unit 58 changes the start intention flag to an off state, the automatic control unit 58 transmits a control signal for turning off the starter 8 to the running control unit 54 to stop the starter 8, and, furthermore, the automatic control unit 58 transmits a control signal for stopping the engine 4 to the running control unit 54, to stop the engine 4.

That is, in the case where the engine 4 is automatically started, when a period of time elapses without the driver 100 operating the accelerator pedal 20 and the counter A becomes larger than or equal to the determination value Nj, it may be interpreted that the driver 100 does not require increasing power of the engine 4. Therefore, in such a case, it is determined that the driver 100 has no intention of starting the vehicle 1, and the engine 4 is stopped. In this way, when control for stopping the engine 4 is executed, the process exits from the procedure.

When the engine 4 is automatically started in the case where the engine 4 is stopped as a result of automatic stop control, starting the engine 4 or keeping the engine 4 stopped is selected on the basis of whether the driver 100 depresses the accelerator pedal 20 at the time of an automatic start in this way.

In this way, when the engine 4 is automatically started in the case where the engine 4 is stopped as a result of automatic stop control, not only the operation state of the clutch pedal 30 but also the operation state of the accelerator pedal 20 after the clutch pedal 30 has begun to be returned is used to select starting the engine 4 or keeping the engine 4 stopped to thereby make it possible to further appropriately determine an intention of the driver 100. As a result, it is possible to further reliably execute appropriate start control along an intention of the driver 100.

In addition, the automatic control system 2 according to the embodiment initiates start control when the depressed clutch pedal 30 has begun to be returned in the case where the engine 4 is automatically started after an automatic stop of the engine 4. When the engine 4 is automatically started during an automatic stop of the engine 4, it may be carried out on the basis of an operation other than the operation of the clutch pedal 30. For example, when the automatic stop condition includes a condition that the brake pedal 24 is depressed, the engine 4 may be automatically controlled in the case where the brake pedal 24 has begun to be returned. Therefore, at the time of selecting starting the engine 4 or keeping the engine 4 stopped during automatic start control over the engine 4, when the operation state of the accelerator pedal 20 is also used, starting the engine 4 or keeping the engine 4 stopped may be selected on the basis of the operation state of the accelerator pedal 20 after the brake pedal 24 depressed to automatically stop the engine 4 has begun to be returned. The driving operation of the driver 100, used to select starting the engine 4 or keeping the engine 4 stopped during automatic start control of the engine 4 may be a mode other than the operation mode of the clutch pedal 30.

In addition, the above described automatic control system 2 executes automatic stop control and automatic start control over the engine 4 on the basis of the state of driving operation of the driver 100, including the operation state of the clutch pedal 30; instead, control executed on the basis of the operation of the clutch pedal 30, or the like, for the purpose of improving fuel economy may be control other than stop control or start control over the engine 4. For example, it is also applicable that, when the clutch pedal 30 is depressed to disengage the clutch 10, not the engine 4 is stopped but power generated by the engine 4 is reduced, and, when the clutch pedal 30 is returned to engage the clutch 10, power generated by the engine 4 is increased. By so doing, when it may be interpreted that the driver 100 does not require driving force because the driver 100 depresses the clutch pedal 30 to disengage the clutch 10, power generated by the engine 4 is reduced, so it is possible to reduce fuel consumption.

In addition, power generated by the engine 4 is increased at the time when the driver 100 returns the clutch pedal 30, so power of the engine 4 may be increased when the driver 100 requires driving force, and it is possible to generate driving force required by the driver 100. As a result, it is possible to achieve both improvement in fuel economy during driving of the vehicle 1 and appropriate running control along an intention of the driver 100.

In addition, in this way, when power generated by the engine 4 is controlled on the basis of the operation of the clutch pedal 30, or the like, it is desirable to change the way of increasing power on the basis of the operation mode of the clutch pedal 30. For example, when the operating speed at which the depressed clutch pedal 30 is returned is faster than a predetermined speed, power generated by the engine 4 may not be increased or power generated by the engine 4 may be limited. In this way, by changing the way of increasing power on the basis of the operation mode of the clutch pedal 30, it is possible to further reliably generate driving force in response to a request from the driver 100, and it is possible to execute appropriate running control along an intention of the driver 100.

In addition, the above described vehicle 1 uses the engine 4 that is an internal combustion engine as a power source for propelling the vehicle 1; instead, a power source, other than the engine 4, may be used instead. For example, a motor (not shown) that operates on electricity may be used as a power source for propelling the vehicle 1. In this case, power generated by the motor may be changed on the basis of the operation mode of the clutch pedal 30. For example, it is applicable that the motor generates creep force when the depressed clutch pedal 30 is returned and limits creep force of the motor when the clutch pedal 30 is returned faster than a predetermined speed. In this way, irrespective of the type of the power source of the vehicle 1, power generated by the power source is varied on the basis of the operation mode of the clutch pedal 30 to thereby make it possible to execute appropriate running control along an intention of the driver 100.

In addition, the determination condition for automatically stopping the engine 4 may be other than the above described conditions. For example, the determination condition may be an elapsed time from when the shift lever 40 is placed at a neutral position or an elapsed time from when the clutch 10 is disengaged. In this case, the elapsed time may be changeable on the basis of the running condition of the vehicle 1, or the like, and may be selectively changeable by the driver 100. In addition, the driving operation based on which it is determined whether to carry out an automatic stop may be other than the driving operation of the clutch pedal 30 or the driving operation of the shift lever 40. For example, an operation to release the accelerator pedal 20 or an operation to depress the brake pedal 24 may also be used as a driving operation based on which it is determined whether to carry out an automatic stop. Determination as to whether to carry out an automatic stop of the engine 4 may be determined comprehensively from these driving operations or determined by setting a determination condition appropriately.

In the above-embodiments, because it is determined whether an engine should be started based on a driver of a vehicle has an intention of starting the vehicle, it is determiner there is no intention of starting the vehicle, the engine does not start even if a shift lever selects any one of a plurality of gears of the transmission (a drive position).

As described above, the engine automatic control system according to the aspect of the invention is useful in a vehicle that automatically stops or starts an engine where necessary without a driver's operation and is, particularly, suitable for a vehicle in which a driver conducts clutch operation during vehicle running.

1-14. (canceled)

15. An engine automatic control system comprising:
a clutch that changes between transmission of power, generated by a power source, to a drive wheel and interruption of the power to the drive wheel;
a clutch operator that engages or disengages the clutch to operate an engagement state of the clutch; and
a control unit that stops or starts the power source on the basis of an operation of the clutch operator, wherein
the control unit starts the power source on the basis of an operation mode in which the clutch operator is operated to engage the clutch during a stop of the power source, and
the control unit selects starting the power source or keeping the power source stopped on the basis of an operating speed at which the clutch operator is operated to engage the clutch during a stop of the power source.

16. An engine automatic control system comprising:
a clutch that changes between transmission of power, generated by a power source, to a drive wheel and interruption of the power to the drive wheel;
a clutch operator that engages or disengages the clutch to operate an engagement state of the clutch; and
a control unit that stops or starts the power source on the basis of an operation of the clutch operator, wherein
the control unit starts the power source on the basis of an operation mode in which the clutch operator is operated to engage the clutch during a stop of the power source, and
the control unit selects starting the power source or keeping the power source stopped on the basis of an operating time during which the clutch operator is operated to engage the clutch during a stop of the power source.

17. The engine automatic control system according to claim 15, further comprising:
an operation range end detector that detects that the clutch operator is placed at any one of a depressing-side end and return-side end of an operation range within which the clutch operator is operated, wherein
in a case where the clutch operator is operated to engage the clutch during a stop of the power source, when a period of time from when the operation range end detector detects that the clutch operator has left from the depressing-side end to when the operation range end detector detects that the clutch operator has reached the return-side end is shorter than a reference time, the control unit keeps the power source stopped.

18. The engine automatic control system according to claim 17, further comprising
a shift operator that selects a neutral position or a drive position,
wherein the control unit keeps the power source stopped even if the shift operator selects the drive position.

19. The engine automatic control system according to claim 15, further comprising:
an operation range end detector that detects that the clutch operator is placed at any one of a depressing-side end and return-side end of an operation range within which the clutch operator is operated, wherein
in a case where the clutch operator is operated to engage the clutch during a stop of the power source, when a period of time elapsed from when the operation range end detector detects that the clutch operator has left from the depressing-side end is longer than or equal to a reference time, the control unit selects starting the power source.

20. The engine automatic control system according to claim 15, wherein
when the power source is started by operating the clutch operator to engage the clutch during a stop of the power source, the control unit interprets whether a driver of a vehicle has an intention of starting the vehicle on the basis of a return speed at which the clutch operator is returned in an intermediate range within an operation range within which the clutch operator is operated.

21. The engine automatic control system according to claim 20, wherein
when the power source is started by operating the clutch operator to engage the clutch during a stop of the power source, the control unit interprets whether a driver of a vehicle has an intention of starting the vehicle on the basis of a difference between a return speed at which the clutch operator is returned in an intermediate range within an operation range within which the clutch operator is returned and a return speed at which the clutch operator is returned in a depressing-side range with respect to the intermediate range within the operation range.

22. The engine automatic control system according to claim 20, further comprising
a shift operator that selects a neutral position or a drive position
wherein the control unit keeps the power source stopped even if the shift operator selects the drive position.

23. An engine automatic control system that stops or starts a power source during running of a vehicle on the basis of driving force required by a driver of the vehicle, comprising:
a clutch that changes between transmission of power, generated by the power source, to a drive wheel and interruption of the power to the drive wheel;
a clutch operator that operates an engagement state of the clutch;
an accelerator operator that adjusts the power generated by the power source; and
a control unit that selects starting the power source or keeping the power source stopped on the basis of an operation state of the accelerator operator after the clutch operator has begun to be returned during a stop of the power source.

24. The engine automatic control system according to claim 23, wherein
when a period of time during which the accelerator operator is not operated after the clutch operator has begun to be returned during a stop of the power source is longer than or equal to a predetermined period of time, the control unit selects keeping the power source stopped.

25. The engine automatic control system according to claim 24, further comprising
a shift operator that selects a neutral position or a drive position
wherein the control unit keeps the power source stopped even if the shift operator selects the drive position.

26. An engine automatic control method using a clutch operator that engages or disengages a clutch, which changes between transmission of power, generated by a power source, to a drive wheel and interruption of the power to the drive wheel, to operate an engagement state of the clutch, comprising:
stopping or starting the power source on the basis of an operation of the clutch operator;
starting the power source on the basis of an operation mode in which the clutch operator is operated to engage the clutch during a stop of the power source; and
selecting starting the power source or keeping the power source stopped on the basis of an operating speed at which the clutch operator is operated to engage the clutch during a stop of the power source.

27. An engine automatic control method using a clutch operator that engages or disengages a clutch, which changes between transmission of power, generated by a power source, to a drive wheel and interruption of the power to the drive wheel, to operate an engagement state of the clutch, comprising:
stopping or starting the power source on the basis of an operation of the clutch operator;
starting the power source on the basis of an operation mode in which the clutch operator is operated to engage the clutch during a stop of the power source; and
selecting starting the power source or keeping the power source stopped on the basis of an operating time during which the clutch operator is operated to engage the clutch during a stop of the power source.

28. An engine automatic control method that stops or starts a power source during running of a vehicle on the basis of driving force required by a driver of the vehicle and that uses a clutch operator that operates an engagement state of a clutch, which changes between transmission of power, generated by the power source, to a drive wheel and interruption of the power to the drive wheel, and an accelerator operator that adjusts the power generated by the power source, comprising:
selecting starting the power source or keeping the power source stopped on the basis of an operation state of the accelerator operator after the clutch operator has begun to be returned during a stop of the power source.

29. The engine automatic control system according to claim 16, further comprising:
an operation range end detector that detects that the clutch operator is placed at any one of a depressing-side end and return-side end of an operation range within which the clutch operator is operated, wherein
in a case where the clutch operator is operated to engage the clutch during a stop of the power source, when a period of time from when the operation range end detector detects that the clutch operator has left from the depressing-side end to when the operation range end detector detects that the clutch operator has reached the return-side end is shorter than a reference time, the control unit keeps the power source stopped.

30. The engine automatic control system according to claim 29, further comprising
a shift operator that selects a neutral position or a drive position,
wherein the control unit keeps the power source stopped even if the shift operator selects the drive position.

31. The engine automatic control system according to claim 16, further comprising:
an operation range end detector that detects that the clutch operator is placed at any one of a depressing-side end and return-side end of an operation range within which the clutch operator is operated, wherein
in a case where the clutch operator is operated to engage the clutch during a stop of the power source, when a period of time elapsed from when the operation range end detector detects that the clutch operator has left from the depressing-side end is longer than or equal to a reference time, the control unit selects starting the power source.

32. The engine automatic control system according to claim 16, wherein
when the power source is started by operating the clutch operator to engage the clutch during a stop of the power source, the control unit interprets whether a driver of a vehicle has an intention of starting the vehicle on the basis of a return speed at which the clutch operator is returned in an intermediate range within an operation range within which the clutch operator is operated.

33. The engine automatic control system according to claim 32, wherein
when the power source is started by operating the clutch operator to engage the clutch during a stop of the power source, the control unit interprets whether a driver of a vehicle has an intention of starting the vehicle on the basis of a difference between a return speed at which the clutch operator is returned in an intermediate range within an operation range within which the clutch operator is returned and a return speed at which the clutch operator is returned in a depressing-side range with respect to the intermediate range within the operation range.

34. The engine automatic control system according to claim 32, further comprising
a shift operator that selects a neutral position or a drive position,
wherein the control unit keeps the power source stopped even if the shift operator selects the drive position.
